(19) United States
(12) Patent Application Publication
(10) Pub. No.: US 2007/0024661 A1
(43) Pub. Date: Feb. 1, 2007

(54) Inkjet image forming apparatus and printing method thereof

(76) Inventors: Tae-kyun Kim, Yongin-si (KR); Young-bok Ju, Seongnam-si (KR)

Correspondence Address: STANZIONE & KIM, LLP, 919 18TH STREET, N.W., SUITE 440, WASHINGTON, DC, 20006, US

(21) Appl. No.: 11/376,343

(22) Filed: Mar. 16, 2006

(30) Foreign Application Priority Data
Jul. 27, 2005 (KR) 2005-68611

(51) Int. Cl. B41J 29/393

(52) U.S. Cl. 347/19

(57) ABSTRACT

An inkjet image forming apparatus and a printing method for the same. In the printing method, a printhead is oscillated according to a type of a print medium to compensate for a malfunctioning nozzle or to perform high resolution printing. Thus, a higher resolution image than an actual resolution of the printhead can be obtained, and printing quality can be enhanced by compensating for a malfunctioning nozzle.

### CROSS-REFERENCE TO RELATED APPLICATIONS

This application claims the benefit of Korean Patent Application No. 2005-68611, filed on Jul. 27, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to a line printing type inkjet image forming apparatus and a printing method thereof, which enhances printing quality.

2. Description of the Related Art

An inkjet image forming apparatus forms images by ejecting ink onto a print medium, and can be classified into two types: a shuttle type inkjet image forming apparatus and a line printing type inkjet image forming apparatus according to the printing manner thereof. The shuttle type inkjet image forming apparatus prints an image using a printhead which reciprocally moves in a direction perpendicular to a transferring direction of the print medium. The line printing type inkjet image forming apparatus prints an image using a printhead which has a nozzle unit having a length corresponding to a width of a print medium.

In the line printing type inkjet image forming apparatus, the printhead is fixed and typically only the print medium is transferred. Accordingly, each nozzle disposed in the printhead ejects ink onto a fixed area on the print medium. Thus, when a nozzle malfunctions, a visible unprinted line, such as a white line, is generated on the print medium P. The printing defect typically does not matter when an image of a low printing density is formed, but the printing defect remarkably affects printing quality when printing a solid pattern or an image of a high printing density. A resolution along the direction perpendicular to the transferring direction of the print medium depends on a distance between nozzles, i.e., a nozzle pitch, and a resolution along the transferring direction of the print medium depends on a transferring speed of the print medium. Accordingly, when a desired resolution for printing is higher than an actual resolution of the printhead when using the line printing type inkjet image forming apparatus having a fixed printhead, it is not easy to print an image on a print medium with high resolution.

U.S. Pat. No. 5,581,284 describes a method of compensating for a malfunctioning nozzle in a line printing type inkjet image forming apparatus. The malfunctioning nozzle indicates a nozzle that either completely fails to eject ink or improperly ejects ink. This method is useful to compensate for the malfunction of a nozzle that ejects black ink, but the method cannot be used to compensate for a malfunction of nozzles that eject other colors. Moreover, since nozzles for cyan, magenta, and yellow ink do not operate when only the black color is printed, a process black can be formed using these nozzles, but when a color image is printed (i.e., when the nozzles for cyan, magenta, and yellow ink operate) the compensation cannot be performed. In addition, when the color inks are used together to compensate for black ink by creating the process black, the use of the color inks is increased. Therefore, lifespan of an ink cartridge is decreased.

Japanese Patent Publication No. 2001-301147 describes a method of enhancing a printing resolution. FIG. 1 is a view illustrating an arrangement of printheads of a conventional inkjet image forming apparatus. FIG. 2 is a perspective view of the conventional inkjet image forming apparatus of FIG. 1. Here, a reference numeral 10 represents a printhead, a reference numeral 11 indicates a nozzle array, a reference numeral 31 represents a printhead unit, a reference numeral 32 represents an ink reservoir assembly, a reference numeral 33 represents an ink supplying pipe, a reference numeral 34 represents a linear motor, and a reference numeral 35 represents a guide rail.

Referring to FIGS. 1 and 2, printing is performed by oscillating the printhead unit 31, which is disposed in units of a half nozzle pitch P/2, with an oscillation amplitude smaller than a nozzle pitch P in a width direction of the print medium. In addition, the printing is performed at least twice at each oscillation, thereby realizing printing with a higher resolution than when printing without oscillation. The oscillation of the printhead unit 31 is performed by the linear motor 34.

However, the oscillation amplitude for the method of FIGS. 1 and 2 is limited within the nozzle pitch P (i.e., a single nozzle pitch), and thus it is impossible to compensate for malfunctioning nozzles in some portions in the printhead 10. In addition, sizes of ink dots deposited on the print medium vary according to the type of the print medium as a result of ink spreading, but in the method of FIGS. 1 and 2, an image is printed without considering the ink spreading. Accordingly, when printing with high resolution, the print medium may curl during printing due to over-ejection of ink. More particularly, when an additional ink dot is deposited on a position between ink dots, printing quality may be degraded as a result of a diffusion of adjacent ink dots since the ink spreading according to the type of the print medium being used is not considered.

### SUMMARY OF THE INVENTION

The present general inventive concept provides an image forming apparatus and a printing method using the same that can print an image with higher resolution than an actual resolution of a printhead of the image forming apparatus.

The present general inventive concept also provides an image forming apparatus and a printing method using the same that can reliably print an image by adjusting an oscillation amplitude of a printhead and an ink ejecting distance when compensating for malfunctioning nozzles or printing with high-resolution.

The present general inventive concept also provides an image forming apparatus and a printing method using the same that can effectively compensate for image degradation caused by malfunctioning nozzles.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an inkjet image forming apparatus including a print medium detecting unit to detect a type of a print medium being used, a print medium transferring unit to transfer the print medium in a first direction, a printhead having a nozzle unit with a length that corresponds to a width of the print medium, and being installed along a second direction, to eject ink onto the print medium to form an image, a carriage movably installed along the second direction and in which the printhead is mounted, a carriage moving unit to oscillate the carriage in the second direction, a malfunctioning nozzle detecting unit to detect whether a malfunctioning nozzle exists in the nozzle unit, and a control unit to generate control signals, when the malfunctioning nozzle is detected to exist, to oscillate the carriage with an oscillation amplitude of more than a single nozzle pitch according to the detected type of the print medium, and to synchronously control the transferring operation of the print medium transferring unit, the ejecting operation of the printhead, and the oscillation operation of the carriage moving unit to compensate for the malfunctioning nozzle by ejecting ink when a normal nozzle is moved to a position where the malfunctioning nozzle is positioned for a previous ejection operation.

The control unit may generate a control signal to eject ink in order to compensate for the malfunctioning nozzle when the carriage arrives at a position that corresponds to a maximum oscillation amplitude.

The control unit may generate a control signal to control motion of the carriage moving unit such that the oscillation amplitude of the carriage is five nozzle pitches.

The printhead may include a plurality of head chips that have a plurality of nozzle arrays and are arranged along the second direction.

The plurality of head chips may be arranged in zigzag formation.

The printhead may include nozzle arrays that have a length that corresponds to the width of the print medium and are arranged along the second direction.

The foregoing and/or other aspects of the present general inventive concept may also be achieved by providing an inkjet image forming apparatus including a print medium confirming unit to confirm a type of a print medium be used, a print medium transferring unit to transfer the print medium in a first direction, a printhead which has a nozzle unit with a length that corresponds to a width of the print medium, and being installed along a second direction to eject ink onto the print medium to form an image, a carriage movably installed in the second direction and in which the printhead is mounted, a carriage moving unit to oscillate the carriage in the second direction, a malfunctioning nozzle detecting unit to detect whether a malfunctioning nozzle exists in the nozzle unit, and a control unit, to generate control signals, when the malfunctioning nozzle is detected, to oscillate the carriage with an oscillation amplitude of more than a single nozzle pitch according to the confirmed type of the print medium, and to synchronously control the transferring operation of the print medium transferring unit, the ejecting operation of the printhead, and the operation of the carriage moving unit to compensate for the malfunctioning nozzle by ejecting ink when a normal nozzle is moved to a position where the malfunctioning nozzle is positioned for a previous ejection operation.

The control unit may generate a control signal to eject ink in order to compensate for the malfunctioning nozzle when the carriage arrives at a position that corresponds to a maximum oscillation amplitude.

The control unit may generate a control signal to control motion of the carriage moving unit such that the oscillation amplitude of the carriage is five nozzle pitches.

The foregoing and/or other aspects of the present general inventive concept may also be achieved by providing an image forming apparatus, including a printhead having a plurality of nozzles and a length that corresponds to a width of a print medium, and a control unit to control movement and operation of the printhead to print in a first resolution mode when a first type of print medium is printed and to print in a second resolution mode when a second type of print medium is printed.

The foregoing and/or other aspects of the present general inventive concept may also be achieved by providing an image forming apparatus, including a printhead having a plurality of nozzles and a length that corresponds to a width of a print medium, and a control unit to determine whether a malfunctioning nozzle exists in the printhead, to control the printhead to perform an initial ink ejection at an initial position, and to control the printhead to move back and forth by a multiple of a single nozzle pitch such that a functioning nozzle that is the multiple of the single nozzle pitch away from the malfunctioning nozzle ejects ink to an area on the print medium that corresponds to the malfunctioning nozzle.

The foregoing and/or other aspects of the present general inventive concept may also be achieved by providing an image forming apparatus, including a printhead having a plurality of nozzles spaced apart by a nozzle pitch and a length that corresponds to a width of a print medium, a malfunctioning nozzle detection unit to detect whether a malfunctioning nozzle exists in the printhead, and a control unit to control the printhead to oscillate with an amplitude of more than one nozzle pitch such that a functioning nozzle ejects ink to an area of the print medium having a missing dot from the malfunctioning nozzle.

The foregoing and/or other aspects of the present general inventive concept may also be achieved by providing an image forming apparatus, including a printhead having a plurality of nozzles and a length that corresponds to a width of a print medium, a print medium determining unit to determine a type of the print medium to be printed, a malfunctioning nozzle detection unit to detect whether a malfunctioning nozzle exists in the printhead, and a control unit to receive information about the determined type of print medium and whether the malfunctioning nozzle exists and to control longitudinal movement and operation of the printhead based on the information received from the print medium determining unit and the malfunctioning nozzle detection unit.

The foregoing and/or other aspects of the present general inventive concept may also be achieved by providing an image forming apparatus including a printhead having a plurality of nozzles to form an image on a printing medium, and a control unit to detect at least one of the plurality nozzles as a malfunctioning nozzle, and to control the printhead to move a distance with respect to a position of the malfunctioning nozzles according to information on a state of the malfunctioning nozzle, a type of the printing medium, and a state of the printhead.

The foregoing and/or other aspects of the present general inventive concept may also be achieved by providing a method of compensating for a malfunctioning nozzle in an inkjet image forming apparatus having a printhead including a nozzle unit with a length corresponding to a width of a print medium, the method including confirming a type of the print medium to be printed, detecting whether a malfunctioning nozzle exists in the nozzle unit, determining to compensate for the malfunctioning nozzle according to the confirmed type of the print medium when the malfunctioning nozzle exists, and compensating for the malfunctioning nozzle by longitudinally oscillating the printhead with an oscillation amplitude of more than a single nozzle pitch according to the type of the print medium and ejecting ink when a normal nozzle is moved to a position where the malfunctioning nozzle is positioned for a previous ejection operation.

The confirmation of the type of print medium may include detecting the type of the print medium using a light-emitting sensor and a light-receiving sensor.

The confirming of the type of print medium may include enabling confirmation of the type of the print medium for printing via a user interface

The compensating for the malfunctioning nozzle may include ejecting ink to compensate for the malfunctioning nozzle when the printhead arrives at a position that corresponds to a maximum oscillation amplitude.

The compensating for the malfunctioning nozzle may include controlling the printhead to oscillate within five nozzle pitches.

The foregoing and/or other aspects of the present general inventive concept may also be achieved by providing a high resolution printing method for an inkjet image forming apparatus having a printhead with a nozzle unit having a length corresponding to a width of a print medium, the method including confirming a type of the print medium to be printed, receiving a desired resolution for printing from a host, comparing the desired resolution and an actual resolution of the printhead, determining whether to oscillate the printhead according to the confirmed type of the print medium, when the desired resolution is greater than the actual resolution of the printhead, and printing with high resolution by longitudinally oscillating the printhead with an oscillation amplitude of more than a single nozzle pitch according to the confirmed type of the print medium such that at least one ink dot is deposited on a position between two adjacent ink dots previously ejected.

The confirming of the type of print medium to be printed may include detecting the type of the print medium using a light-emitting sensor and a light-receiving sensor.

The confirming of type of print medium to be printed may include enabling confirmation of the type of the print medium to be printed via a user interface.

The printing may include moving the printhead in a stepwise manner in the longitudinal direction by a magnitude of D/N for “n” print times with respect to an initial position of the printhead such that at least one ink dot may be ejected onto each position of a D/N interval between two adjacent ink dots previously ejected, where “n” represents a natural number, “D” represents a distance between two adjacent nozzles and a nozzle pitch, and “N” represents a ratio of the desired resolution to the actual resolution of the printhead.

The print medium is transferred at 1/N of a print medium transferring speed in a normal printing mode in which the image forming apparatus does not print with the high resolution.

The printing may include oscillating the printhead in the longitudinal direction by a magnitude of (m/N)*D +(n*D) for N−1 printing times with respect to an initial position of the printhead to eject at least one ink droplet onto each position of a D/N interval between two adjacent nozzles, where “n” represents an integral number, “D” represents a distance between two adjacent nozzles and a nozzle pitch, “N” represents a ratio of the desired resolution to the actual resolution of the printhead, and “m” represents a number which is sequentially changed from 1 up to N−1 whenever the printhead is oscillated.

The printhead may eject ink when the printhead arrives at a position that corresponds to a maximum oscillation amplitude.

The print medium may be transferred at 1/N of a print medium transferring speed in a normal printing mode in which the image forming apparatus does not print with the high resolution.

The print medium may be transferred for printing slower than in a normal printing mode in which the image forming apparatus does not print with the high resolution.

The foregoing and/or other aspects of the present general inventive concept may also be achieved by providing a method of controlling an image forming apparatus including a printhead having a plurality of nozzles and a length that corresponds to a width of a print medium, the method including controlling movement and operation of the printhead to print in a first resolution mode when a first type of print medium is printed, and controlling movement and operation of the printhead to print in a second resolution mode when a second type of print medium is printed.

The foregoing and/or other aspects of the present general inventive concept may also be achieved by providing a method of controlling an image forming apparatus including a printhead having a plurality of nozzles and a length that corresponds to a width of a print medium, the method including determining whether a malfunctioning nozzle exists in the printhead, controlling the printhead to perform an initial ink ejection at an initial position thereof, and controlling the printhead to move back and forth by a multiple of a single nozzle pitch such that a functioning nozzle that is the multiple of the single nozzle pitch away from the malfunctioning nozzle ejects ink to an area on the print medium that corresponds to the malfunctioning nozzle.

The foregoing and/or other aspects of the present general inventive concept may also be achieved by providing a method of controlling an image forming apparatus including a printhead having a plurality of nozzles spaced apart by a nozzle pitch and a length that corresponds to a width of a print medium, the method including detecting whether a malfunctioning nozzle exists in the printhead, and controlling the printhead to oscillate with an amplitude of more than one nozzle pitch such that a functioning nozzle ejects ink to an area of the print medium having a missing dot from the malfunctioning nozzle.

The foregoing and/or other aspects of the present general inventive concept may also be achieved by providing a method of an image forming apparatus including a printhead having a plurality of nozzles and a length that corresponds to a width of a print medium, the method including determining a type of the print medium to be printed, detecting whether a malfunctioning nozzle exists in the printhead, and controlling longitudinal movement and operation of the printhead based on information received from the print medium determining unit and the malfunctioning nozzle detection unit indicating whether the malfunctioning nozzle exists and the determined type of print medium.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a view illustrating an arrangement of printheads of a conventional inkjet image forming apparatus;

FIG. 2 is a perspective view illustrating the conventional inkjet image forming apparatus of FIG. 1;

FIG. 3 is a schematic cross-sectional view illustrating an inkjet image forming apparatus according to an embodiment of the present general inventive concept;

FIG. 4 illustrates a printhead unit of the inkjet image forming apparatus of FIG. 3 according to an embodiment of the present general inventive concept;

FIG. 5 illustrates a driving mechanism of the printhead of FIG. 4, according to an embodiment of the present general inventive concept;

FIG. 6 is a perspective view illustrating a carriage moving unit according to an embodiment of the present general inventive concept;

FIG. 7 is a perspective view illustrating a carriage moving unit according to another embodiment of the present general inventive concept;

FIG. 8 is a block diagram illustrating an image forming system according to an embodiment of the present general inventive concept;

FIG. 9 is a block diagram illustrating operation of an image forming apparatus according to an embodiment of the present general inventive concept;

FIG. 10 illustrates changes in dot sizes when the same amount of ink droplets is deposited on different print media;

FIG. 11 illustrates print patterns according to different types of print media when a missing dot is generated.

FIG. 12 is a flow chart illustrating a method of compensating for a malfunctioning nozzle according to an embodiment of the present general inventive concept;

FIG. 13A illustrates a printing pattern when a malfunctioning nozzle is compensated for when using plain paper;

FIG. 13B illustrates a printing pattern when a malfunctioning nozzle is compensated for when using photo paper or coated paper;

FIG. 13C illustrates a printing pattern when a malfunctioning nozzle is compensated for when using a transparent film;

FIG. 14 is a flow chart illustrating a high resolution printing method for an inkjet image forming apparatus according to an embodiment of the present general inventive concept;

FIG. 15A illustrates a printing pattern when printing with high resolution on photo paper or coated paper; and

FIG. 15B illustrates a printing pattern when printing with high resolution on a transparent film.

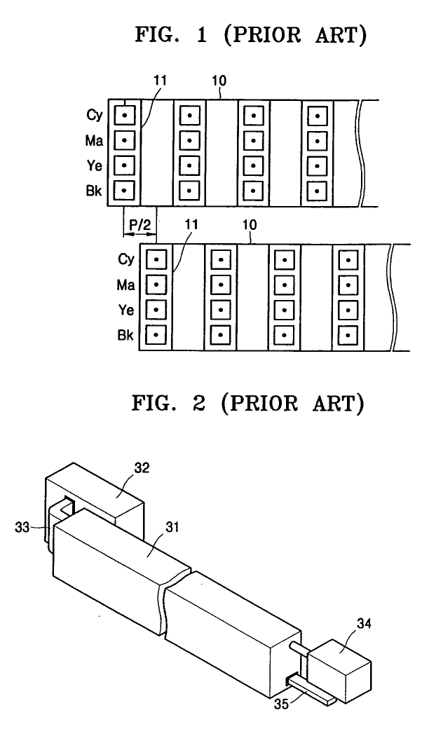

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An inkjet image forming apparatus including printheads and a method of compensating for a malfunctioning nozzle will now be described more fully with reference to the accompanying drawings, in which exemplary embodiments of the general inventive concept are illustrated. For convenience of explanation, the entire structure of embodiments of the inkjet image forming apparatus will be described first, and then the embodiments of the method of compensating for the malfunctioning nozzle will be described. In the drawings, the thicknesses of lines and sizes are exaggerated for clarity and convenience.

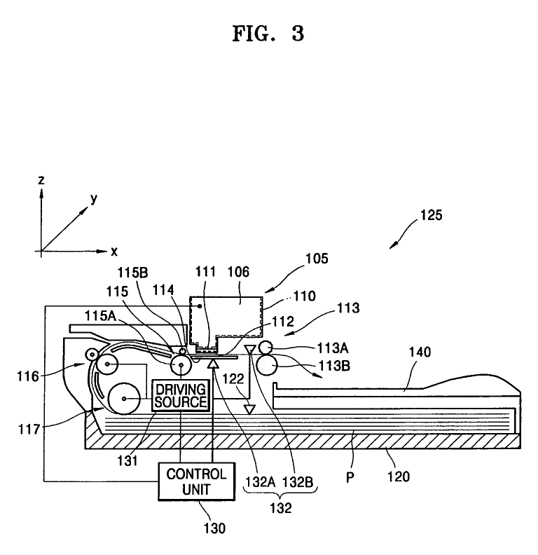

FIG. 3 is a cross-sectional view illustrating an inkjet image forming 125 apparatus according to an embodiment of the present general inventive concept.

Referring to FIG. 3, the inkjet image forming apparatus 125 includes a feeding cassette 120, a printhead unit 105, a supporting member 114 opposite to the printhead unit 105, a malfunctioning nozzle detecting unit 132 to detect a malfunctioning nozzle, a print medium transferring unit 500 (not shown in FIG. 3) to transfer a print medium P in a first direction (i.e., an x direction) along a predetermined path, and a stacking unit 140 on which the discharged print medium P is stacked. In addition, the inkjet image forming apparatus 125 further includes a control unit 130 to control each component thereof. The inkjet image forming apparatus 125 further includes a body 110 having the printhead unit 105 with a printhead 111 mounted on a bottom surface thereof, and a nozzle unit 112 mounted on the printhead 111. The printhead unit 105 may be mounted in a carriage 106 to be movable thereby.

The print medium P is stacked on the feeding cassette 120. The print medium P is transferred from the feeding cassette 120 under the printhead 111 to the stacking unit 140 by the print medium transferring unit 500, which will be described later.

The print medium transferring unit 500 transfers the print medium P along a predetermined path and includes a pick-up roller 117, an auxiliary roller 116, a feeding roller 115, and a discharging roller 113. These elements of the print medium transferring unit 500 are driven by a driving source 131, such as a motor, and provide a transferring force to transfer the print medium P. The driving source 131 is controlled by the control unit 130, which will be described later. That is, the control unit 130 controls the operation of the driving source 131 to set a speed (i.e., a transfer speed) of the print medium P.

The pick-up roller 117 is installed at one side of the feeding cassette 120 and picks up the print medium P stacked in the feeding cassette 120. The feeding roller 115 is installed at an inlet side of the printhead 111 and feeds the print medium P drawn out by the pick-up roller 117 to the printhead 111. The feeding roller 115 includes a driving roller 115A to supply a transferring force to transfer the print medium P, and an idle roller 115B elastically engaged with the driving roller 115A. The auxiliary roller 116 that transfers the print medium P may be further installed between the pick-up roller 117 and the feeding roller 115. The discharging roller 113 is installed at an outlet side of the printhead 111 and discharges the print medium P, on which the printing has been completed, outside of the image forming apparatus 125. The discharged print medium P is stacked on the stacking unit 140.

The discharging roller 113 includes a star wheel 113A installed along a width direction of the print medium P, and a supporting roller 113B which is opposite to the star wheel 11 3A and supports a rear side of the print medium P The print medium P may wrinkle due to ink ejected onto a top side of the print medium P while passing through the nozzle unit 112. A distance between the print medium P and the nozzle unit 112 may not be maintained due to the wrinkles of the print medium P. The star wheel 11 3A prevents the print medium P fed under the nozzle unit 112 from contacting a bottom surface of the nozzle unit 112 or the body 110, or prevents the distance between the print medium P and the bottom surface of the nozzle unit 112 or the body 110 from being changed. The star wheel 11 3A is installed such that at least a portion of the star wheel 113A protrudes from the nozzle unit 112, and contacts at a point of a top surface of the print medium P.

The supporting member 114 is installed below the printhead 111 and supports a rear side of the print medium P to maintain a predetermined distance between the nozzle unit 112 and the print medium P The distance between the nozzle unit 112 and the print medium P may be about 0.5-2.5 mm.

The malfunctioning nozzle detecting unit 132 detects a malfunctioning nozzle, which is generated in a manufacturing process or during printing. The malfunctioning nozzle detecting unit 132 may include a first malfunctioning nozzle detecting unit 132A and a second malfunctioning nozzle detecting unit 132B. The malfunctioning nozzle may be a nozzle that either completely fails to eject ink or ejects ink improperly. That is, the malfunctioning nozzle exists when ink is not ejected from nozzles or when a smaller amount of ink than normal is ejected. The malfunctioning nozzle is generated in a process of manufacturing the printhead 111 or during printing. In general, information about the malfunctioning nozzle generated in the manufacturing process is stored in a memory (not illustrated) installed in the printhead 111. The information can be transmitted to the image forming apparatus 125 when the printhead 111 is mounted in the image forming apparatus 125.

In general, a printhead of an inkjet image forming apparatus can be classified into two types according to an actuator that provides an ejecting force to ink droplets. A first type is a thermal driving printhead that generates bubbles in the ink using a heater, thereby ejecting the ink droplets due to an expanding force of the bubbles. A second type is a piezoelectric driving printhead that ejects the ink droplets using a pressure applied to the ink due to deformation of a piezoelectric device. When the ink is ejected using thermal driving, a situation in which a heater used to eject the ink from the nozzle is disconnected or a driving circuit of the heater is broken or malfunctions, can be easily detected. Likewise, when the ink is ejected using piezoelectric driving, defects in the piezoelectric device or malfunctions of nozzles occurring as a result of damage by a driving circuit for driving the piezoelectric device can be easily detected. In other words, these type of causes of malfunctions of the nozzles can be detected by malfunctioning nozzle detecting unit 132A before a printing operation begins.

On the other hand, causes of a malfunctioning nozzle may not be easily detected when a nozzle is clogged with foreign matters. When the causes of the malfunctioning nozzle cannot be easily detected, a test page printing is performed. If a malfunctioning nozzle exists in the nozzle unit 112, due to missing dots, a print concentration of a portion of the print medium P printed by the malfunctioning nozzle is lower than a portion of the print medium P printed by a normal (i.e., non-malfunctioning) nozzle. Since the portion of the print medium P printed with the lower concentration is detected by the second malfunctioning nozzle detecting unit 132B, the position of the malfunctioning nozzle can also be determined using the second malfunctioning nozzle detecting unit 132B.

The first malfunctioning nozzle detecting unit 132A detects whether nozzles are clogged by radiating light directly onto the nozzle unit 112, and the second malfunctioning nozzle detecting unit 132B detects whether a malfunctioning nozzle exists in the nozzle unit 112 by radiating light onto the print medium P when the print medium P is transferred.

In another embodiment of the present general inventive concept, nozzle inspection signals may be transmitted to each of the nozzles disposed in the printhead 111 and a malfunctioning nozzle can be detected according to a responding signal from each of the nozzles. Methods of detecting a malfunctioning nozzle should be known to a person skilled in the art, and thus detailed descriptions thereof will not be provided. In addition, other various apparatuses and methods can be used to detect a malfunctioning nozzle.

The detection unit 132 includes an optical sensor. The optical sensor includes a light-emitting part (not shown) (e.g., a light emitting diode) that radiates light onto the print medium P and a light-receiving sensor (not shown) that receives light reflected from the print medium P. An output signal from the light-receiving sensor is input to the second malfunctioning nozzle detecting unit 132B. The second malfunctioning nozzle detecting unit 132B detects whether a malfunctioning nozzle exists in the nozzle unit 112 in response to the output signal received from the light-receiving sensor, and information about whether the malfunctioning nozzle exists in the nozzle unit 112 is recorded in a memory (not shown) associated with the printhead 111 and transmitted to the control unit 130. The light-emitting part and the light-receiving sensor can be formed as a one-body type or as several separate units. Structures and functions of the optical sensor should be known to those of skill in the art, and thus a detailed description thereof will not be provided.

The malfunctioning nozzle detecting unit 132 detects whether the malfunctioning nozzle exists in the nozzle unit 112 using the above-described series of processes and/or operations. Information about the malfunctioning nozzle detected by the detecting unit 132 is stored in the memory associated with the printhead 111 and the control unit 130 controls operation of each component of the inkjet image forming apparatus 125 according to the information about the malfunctioning nozzle stored in the memory associated with the printhead 111.

The printhead unit 105 prints an image by ejecting ink onto the print medium P, and includes the body 110, the printhead 111 installed at one side of the body 110, the nozzle unit 112 formed on the printhead 111, and the carriage 106 in which the body 110 is mounted. The body 110 is mounted in the carriage 106 as a cartridge type and the carriage 106 is movably installed along the second direction (i.e., a y direction) which is a longitudinal direction of the printhead 111, by a carriage moving unit 161 (not shown in FIG. 3), which will be described later. The feeding roller 115 is rotatably installed at an inlet side of the nozzle unit 112, and the discharging roller 113 is rotatably installed at an outlet side of the nozzle unit 112.

Although not illustrated, a removable cartridge type ink container is provided in the body 110. Further, the body 110 may include chambers, each of which has ejecting units, for example, piezoelectric elements or heat-driving type heaters that are connected to respective nozzles of the nozzle unit 112 and provide pressure to eject the ink. The cartridge type ink container may further include a passage, for example, an orifice, to supply the ink contained in the body 110 to each chamber, a manifold that is a common passage to supply the ink flowing through the passage to the chamber, and a restrictor that is an individual passage to supply the ink from the manifold to each chamber respectively. The chamber, the ejecting unit, the passage, the manifold, and the restrictor should be known to a person skilled in the art, and thus detailed descriptions thereof will not be provided. In addition, the cartridge type ink container may be separately installed from the printhead unit 105. The ink stored in the ink container may be supplied to the printhead unit 105 through a supplying unit similar to a hose.

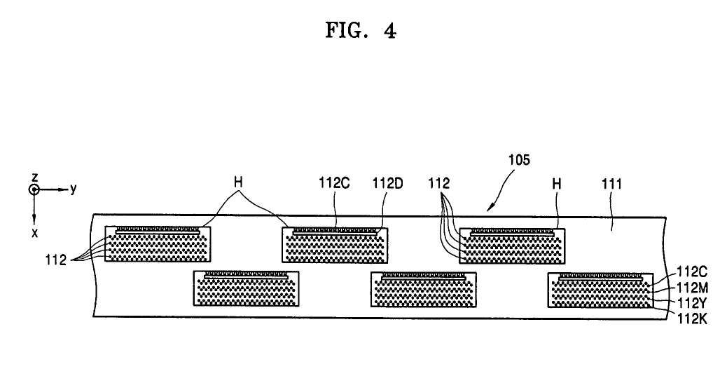

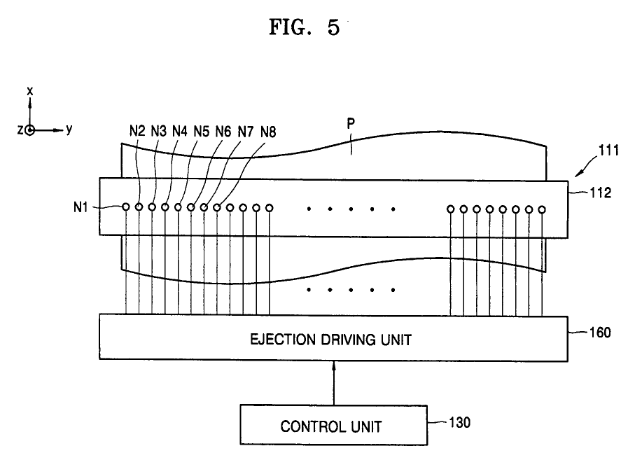

FIG. 4 illustrates the printhead unit 105 having the printhead 111 according to an embodiment of the present general inventive concept. It should be understood that the arrangement at the printhead unit 105 is not intended to limit the scope of the present general inventive concept, and other arrangements may also be used. FIG. 5 illustrates a driving mechanism of the printhead 111 of FIG. 4, according to an embodiment of the present general inventive concept. For convenience of explanation, like reference numerals in the drawings represent similar elements. In FIG. 5, reference characters N1 through N8 represent nozzles disposed in the nozzle unit 112. A single nozzle array disposed in the nozzle unit 112 is described as an example.

Referring to FIGS. 3 and 5, an ejection driving unit 160 provides an ejecting force to ink droplets, and drives the printhead 111 with a predetermined frequency to print an image on the print medium P. As described above, the ejection driving unit 160 can be classified into two types according to an actuator that provides an ejecting force to the ink droplets. The first type is a thermal driving printhead that generates bubbles in the ink using a heater, thereby ejecting the ink droplets due to an expanding force of the bubbles. The second type is a piezoelectric driving printhead that ejects the ink droplets using a pressure applied to the ink due to deformation of a piezoelectric device. The ejection driving unit 160 driving the nozzles in the nozzle unit 112 is controlled by the control unit 130.

Referring to FIGS. 3 and 4, the printhead 111 is installed along the second direction (i.e., the y direction) with respect to the print medium P being transferred along the first direction (i.e., the x direction).

The printhead 111 uses heat energy or the piezoelectric device as an ink ejecting source, and is made to have a high resolution through a semiconductor manufacturing process including, for example, etching, deposition, and/or sputtering.

The printhead unit 111 includes the nozzle unit 112 which prints the image by ejecting the ink onto the print medium P. The nozzle unit 112 may have a length equal to or longer than a width of the print medium P. The nozzle unit 112 installed in the printhead 111 is reciprocally moved along the second direction (i.e., the y direction) by the carriage moving unit 161 (not shown).

Referring to FIG. 4, a plurality of head chips H having a plurality of nozzle row arrays 112C, 112M, 112Y, and 112K may be formed in the printhead 111. Each of the head chips H has a driving circuit 112D which drives nozzles selectively or in units of a group of nozzles. In addition, when the plurality of head chips H are arranged in a single line, a distance between the head chips H may become greater than a distance between the nozzles in the same head chips H, thereby generating an unprinted portion. Therefore, the plurality of head chips H may be arranged in a zigzag shape. The nozzle arrays among the nozzle arrays 112C, 112M, 112Y, and 112K in the head chips H which eject ink of the same color, may be disposed to overlap with one another along the first direction to enhance printing resolution in the second direction, (i.e., the y direction). In this case, ink dots ejected by the nozzles in the nozzle arrays are deposited on positions between ink dots ejected by the nozzles in the other nozzle arrays, thereby enhancing printing resolution in the second direction (i.e., the y direction). The printhead 111 having the nozzle unit 112 of the plurality of head chips H is described as an example in the present embodiment, however, the nozzle unit 112 may have various other shapes. Each of the head chips H may be formed of one chip having a length equal to that of the printhead 111 (i.e., the width of the print medium P). Also, as illustrated in FIG. 5, a nozzle array disposed in the printhead 111 may be arranged along the second direction. Accordingly, the nozzle unit 112 illustrated in FIGS. 4 and 5 is not intended to limit the scope of the present general inventive concept.

Each of the nozzles in the nozzle unit 112 includes the driving circuit 112D and a cable (not shown) to receive printing data, electric power, control signals, etc. The cable may be a flexible printed circuit (FPC) or a flexible flat cable (FFC).

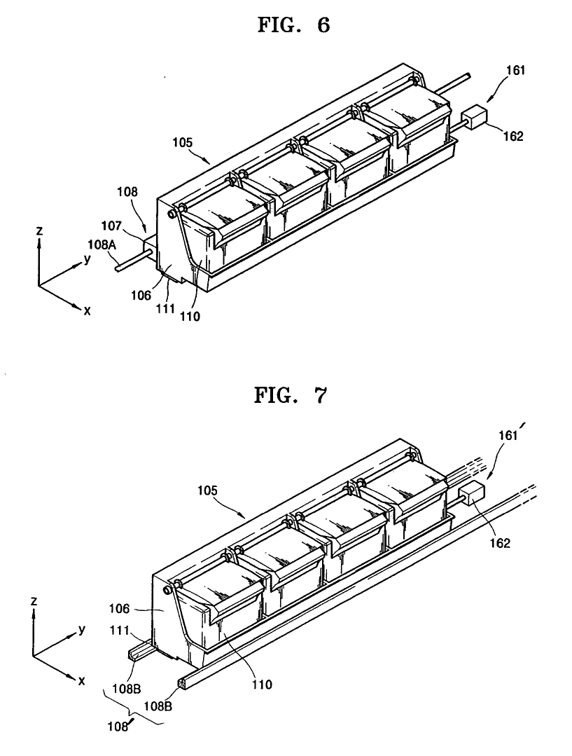

FIG. 6 is a perspective view of the carriage moving unit 161 according to an embodiment of the present general inventive concept FIG. 7 is a perspective view of a carriage moving unit 161′ according to another embodiment of the present general inventive concept. Either the carriage moving unit 161 of FIG. 6 or the carriage moving unit 161′ of FIG. 7 may be used in the image forming apparatus 125 of FIG. 3 to move the carriage to 106.

Referring to FIGS. 4, 6, and 7, the carriage 106 is movably installed along the second direction (i.e., the y direction), in which the printhead 111 is mounted. The carriage moving unit 161 (161′ ) oscillates the carriage 106 in the second direction (i.e., the y direction), which is a longitudinal direction of the printhead 111. When compensating for a malfunctioning nozzle or printing with high resolution, the carriage moving unit 161 (161′ ) oscillates the carriage 106 “n” steps with a predetermined uniform oscillation amplitude. The carriage moving unit 161 (161′ ) oscillates the carriage 106 in a stepwise manner once or by a predetermined magnitude “n” times. Operation of the carriage moving unit 161 (161′ ) is controlled by the control unit 130.

The carriage moving unit 161 (161′ ) includes a driving unit 162 to oscillate the carriage 106 along the second direction (i.e., the y direction). A piezoelectric device used to drive an accurate device such as an optical mirror can be used as the driving unit 162. The piezoelectric device driven by an electric voltage has a position accuracy of several microns μm and a high frequency response characteristic. Accordingly, when the driving unit 162 is the piezoelectric device, the position of the carriage 106 can be accurately controlled. In the present embodiment, oscillating the carriage 106 using the piezoelectric device is described as an example, however, this description is exemplary and is not intended to limit the scope of the present general inventive concept. The piezoelectric device should be known to a person skilled in the art, and thus detailed descriptions thereof will not be provided. In addition, a linear motor, a step motor, or a pulse motor may be used as the driving unit 162 to oscillate the carriage 106. The oscillating motion of the carriage 106 may be controlled by the motor and an encoder sensor.

The carriage moving unit 161 (161′ ) may further include a guide unit 108 (108′ ) to guide the oscillating motion of the carriage 106. As illustrated in FIG. 6, the guide unit 108 may include a combining unit 107 and a guide shaft 108A. The combining unit 107 is perforated at one side of the carriage 106. The guide shaft 108A may be installed on a main frame of the image forming apparatus 125 (see FIG. 3) and inserted into the combining unit 107 formed in a hollow shape to guide the oscillating motion of the carriage 106. That is, the carriage 106 is installed to slide with respect to the guide shaft 108A. As illustrated in FIG. 7, the guide unit 108′ may alternatively include guide rails 108B. The guide rails 108B may be installed at one or both sides of the carriage 106 and guide the oscillating motion of the carriage 106.

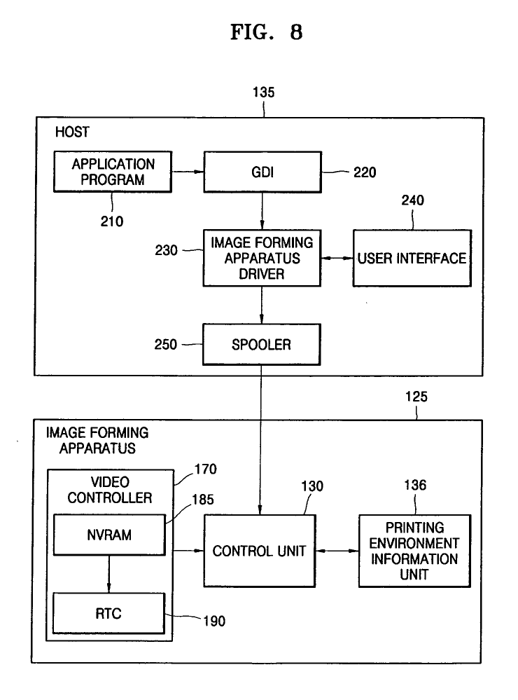

FIG. 8 is a block diagram illustrating an image forming system including the image forming apparatus 125 according to an embodiment of the present general inventive concept. FIG. 9 is a block diagram illustrating operation of the image forming apparatus 125 according to an embodiment of the present general inventive concept. The image forming system includes a data input 135(e.g., a host system) and the inkjet image forming apparatus 125.

Referring to FIG. 8, the data input unit 135 is the host system such as a personal computer (PC), a digital camera, or a personal digital assistant (PDA), and receives image data in the order of pages to be printed. The data input unit 135 includes an application program 210, a graphics device interface (GDI) 220, an image forming apparatus driver 230, a user interface 240, and a spooler 250. The application program 210 generates and edits an object that can be printed by the image forming apparatus 125. The GDI 220, which is a program installed in the host, receives the object from the application program 210, provides the object to the image forming apparatus driver 230, and generates commands related to the object in response to a request from the image forming apparatus driver 230. The image forming apparatus driver 230 is a program installed in the host to generate commands that can be interpreted by the image forming apparatus 125. The user interface 240 for the image forming apparatus driver 230 is a program installed in the host system and provides environment variables with which the image forming apparatus driver 230 generates commands. A user may select, via the user interface 240, a print mode such as a draft mode, a normal mode, and a high-resolution mode. Additionally, the user may select a print medium such as plain paper, photo paper, and a transparent film. The spooler 250 is a program installed in an operating system of the data input unit 135 that transmits the commands generated by the image forming apparatus driver 230 to an input/output device (not shown) that is connected to the image forming apparatus 125.

The inkjet image forming apparatus 125 includes a video controller 170, the control unit 130, and a printing environment information unit 136. The video controller 170 includes a non-volatile random access memory (NVRAM) 185, a static random access memory (SRAM, not shown), a synchronous dynamic random access memory (SDRAM, not shown), a NOR Flash (not shown), and a real time clock (RTC) 190. The video controller 170 interprets the commands generated by the image forming apparatus driver 230 to convert the commands into corresponding bitmaps and transmits the bitmaps to the control unit 130. The control unit 130 then transmits the bitmaps to each component of the image forming apparatus 125 to print an image on the print medium P. Through above described processes, the image forming apparatus 125 prints the image.

In general, sizes of the ink droplets deposited on the print medium P are varied according to different types of print medium P. That is, even when the same amount of ink is ejected, the sizes of the ink droplets deposited on the print medium P are varied according to the different types of the print medium P. Accordingly, when a malfunctioning nozzle is compensated for or when printing with high resolution, the printing process should be adjusted according to the type of the print medium P being printed. Hereinafter, a method of confirming the type of the print medium P being printed will be described.

Referring to FIG. 9, a print medium detecting unit 122 may include a light-emitting sensor and a light-receiving sensor and may be installed above the feeding cassette 120 or on a transferring pathway of the print medium P. The print medium detecting unit 122 radiates light onto the print medium P and detects a type of the print medium P being used from the reflected light. Accordingly, the print medium detecting unit 122 detects the print medium P as plain paper, photo paper, coated paper, or a transparent film such as over head project (OHP) film. A user can confirm the type of the print medium P using a print medium confirming unit. The print medium confirming unit may be the user interface 240 and a driver (not shown) installed in the image forming apparatus 125 such that the user can select the type of the print medium P. In addition, various apparatuses and methods can be used to detect the type of the print medium P. Thus, the print medium confirming unit, as used throughout this description, may be understood to refer to the user interface 240 and/or the print medium detecting unit 122.

Referring to FIGS. 8 and 9, the control unit 130 is mounted on a motherboard (not shown) of the image forming apparatus 125, and controls an ejecting operation of the nozzle unit 112 installed in the printhead 111, a transferring operation of the print medium transferring unit 500, and an oscillating operation of the carriage 106 according to the existence (or absence) of the malfunctioning nozzle, the type of the print medium P being printed and/or the selected print mode. That is, the control unit 130 synchronizes the operation of each component so that the ink ejected from the nozzle unit 112 and a compensating solution ejected from a compensating nozzle unit (not shown) can be deposited on a desired area of the print medium P according to the detection of a malfunctioning nozzle by the malfunctioning nozzle detecting unit 132, or information about the type of the print medium P detected by print medium detecting unit 122 or input to the user interface 240. For example, when printing with high resolution,(i.e., in the high resolution mode) the control unit 130 synchronizes the operation of each component so that the print medium P is slowly transferred, the carriage 106 is oscillated, and thus ink can be deposited on positions between ink dots previously ejected from the nozzle unit 112. The compensating unit may be a compensating nozzle unit disposed on the printhead 111 adjacent to the nozzle unit 112 to eject the compensation solution to an area of a missing dot such that the compensation solution bleeds two adjacent color ink dots to the area of the missing dot, thereby compensating for a malfunctioning nozzle.

In addition, the control unit 130 stores image data input from the data input unit 135 in a memory 137, and confirms whether the image data desired to be printed is completely stored in the memory 137.

The printing environment information unit 136 stores a plurality of printing environment information corresponding to each printing environment, when the image data input from the application program 210 is printed in a predetermined printing environment. That is, the printing environment information unit 136 stores the printing environment information corresponding to each printing environment input from the user interface 240. Here, the printing environment includes at least one of a printing density, a resolution, a size of the print medium P, the type of print medium P, a temperature, a humidity, and a continuous printing. The control unit 130 controls operations of the ejection driving unit 160, the carriage moving unit 161 (161′ ), and the driving source 131 in each printing environment stored in the printing environment information unit 136 corresponding to the input printing environment. For example, the printing environment information unit 136 stores the type of the print medium detected by the print medium P detecting unit 122, the printing environment information about the print mode input through the user interface 240.

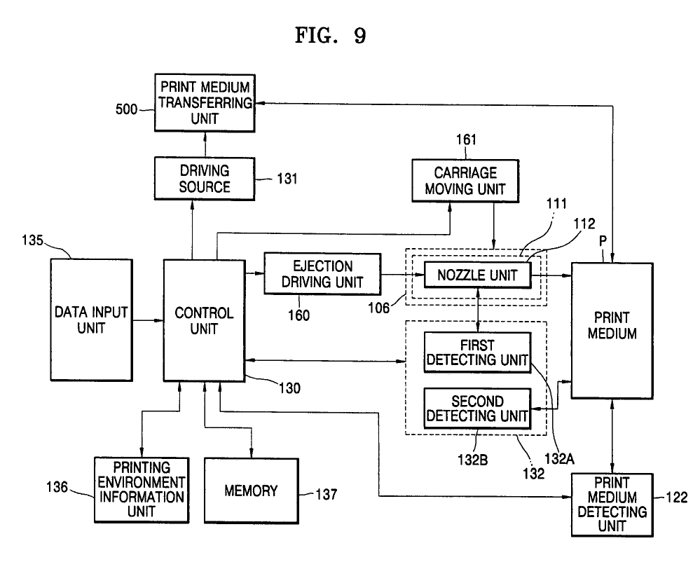

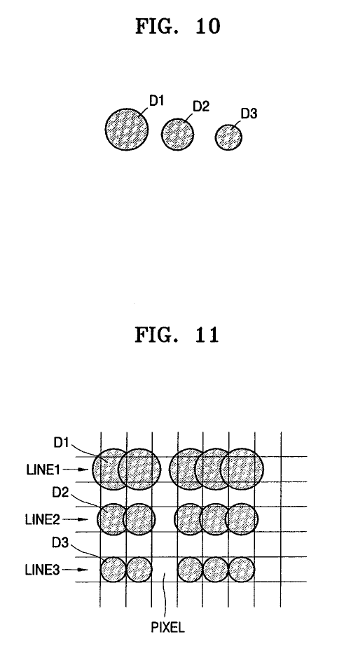

FIG. 10 illustrates changes in dot sizes when the same amount of ink is deposited on different print media. Referring to FIG. 10, even when the same amount of ink is deposited on the print medium P, dot sizes vary according to the type of the print medium P. When an ink droplet D1 is deposited on the print medium P such as plain paper, ink easily spreads and the dot size is relatively large. When an ink droplet D2 is deposited on the print medium P such as photo paper or coated paper, ink spreads less and the dot size is smaller. Since a transparent film has a waterproof surface, an ink droplet D3 deposited thereon does not spread and thus the dot size is the smallest. Therefore, although the same amount of the ink is deposited on the print medium P of different types, the dot sizes vary according to the type of the print medium P.

FIG. 11 illustrates print patterns according to the different types of print media, when a missing dot is generated. Referring to FIG. 11, LINE 1 includes a print pattern when ink droplets are deposited on plain paper, LINE 2 includes a print pattern when ink droplets are deposited on photo paper or coated paper, and LINE 3 includes a print pattern when ink droplets are deposited on a transparent film. In addition, each rectangle indicates each pixel where ink droplets are deposited.

As illustrated in LINE 1 of FIG. 11, when printing onto the plain paper, the dot size D1 is large (i.e., approximately 100 μm), and a pixel unfilled because of a missing dot may not be seen or noticed. Moreover, since boundaries of the ink dots D1 printed on the plain paper in LINE 1 become unclear due to feathering, effects of the missing dot cannot be seen. Accordingly, when printing onto the plain paper, even if the compensating solution is ejected using nozzle in the compensating nozzle unit adjacent (not shown) to a malfunctioning nozzle, image degradation due to the malfunctioning nozzle cannot be seen.

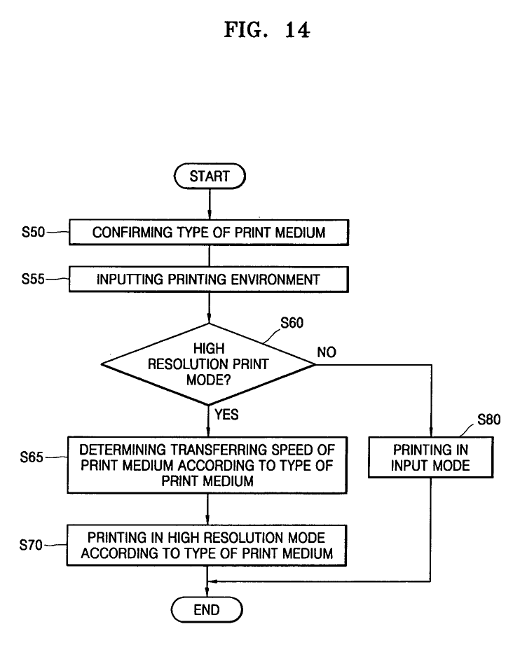

As illustrated in LINE 2 of FIG. 11, the ink droplets D2 deposited on the photo paper or the coated paper are smaller than the ink droplets deposited on the plain paper. The ink dots D2 deposited on the photo paper or the coated paper have a diameter of approximately 50 to 70 μm and a clear boundary. Accordingly, when a malfunctioning nozzle exists, a degradation due to the malfunctioning nozzle can be easily seen, and thus the malfunctioning nozzle should be compensated for. Furthermore, since the ejected ink cannot penetrate a transparent film such as an OHP film, the dot size D3 is too small (i.e., less than approximately 50 μm after drying) as illustrated in LINE 3 of FIG. 14, such that the missing dot can be easily seen. Therefore, when the transparent film is used for printing, a malfunctioning nozzle should be compensated for. That is, as described above, when a malfunctioning nozzle exists, whether the malfunctioning nozzle should be compensated for may be determined according to the print medium type being used.

Hereinafter, a printing method according to an embodiment of the present general inventive concept will be described in detail, in conjunction with the operation of the control unit 130.

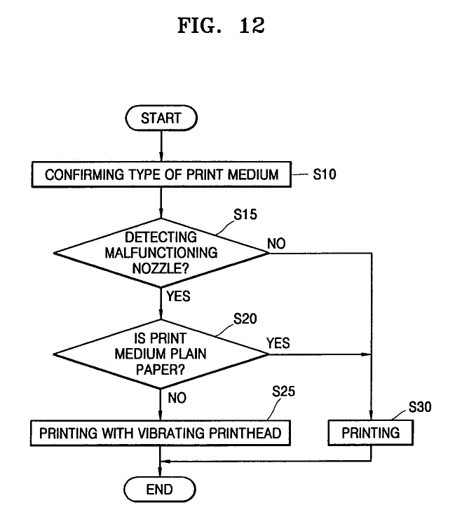

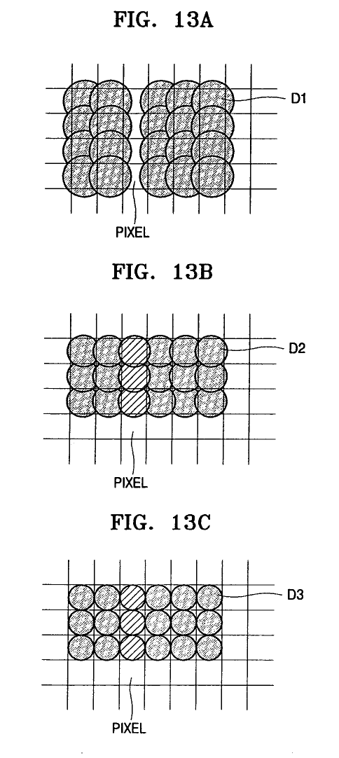

FIG. 12 is a flow chart illustrating a method of compensating for a malfunctioning nozzle according to an embodiment of the present general inventive concept. The control unit 130 of the image forming apparatus 125 may perform the method of FIG. 12. Accordingly, for illustration purposes, the method of FIG. 12 is described below with reference to FIGS. 3 to 9. FIG. 13A illustrates a printing pattern when a malfunctioning nozzle is compensated for when using the plain paper. FIG. 13B illustrates a printing pattern when a malfunctioning nozzle is compensated for when using the photo paper or the coated paper. FIG. 13C illustrates a printing pattern when a malfunctioning nozzle is compensated for when using transparent film.

Referring to FIGS. 8, 9 and 12, the image forming apparatus 125 receives the image data to be printed from the data input unit 135. The type of the print medium P is the information input from the print medium confirming unit including the print medium detecting unit 122 and/or the user interface 240 in operation S50, and the information about the type of the print medium P is transmitted to the control unit 130. As described above, information about a malfunctioning nozzle in the nozzle unit 112 is detected by the malfunctioning nozzle detecting unit 132 and is stored in the memory associated with the printhead 111 in operation S15. The information about the malfunctioning nozzle is also transmitted to the control unit 130. If a malfunctioning nozzle does not exist, the printing is performed according to a normal printing process in operation S30. Otherwise, if the malfunctioning nozzle exists, a printing process varies according to the type of the print medium P being used. That is, when the malfunctioning nozzle exists, a manner in which to compensate for the malfunctioning nozzle is determined according to the type of the print medium P being used in operation S20. As described above, when the plain paper is used for printing, the effects of the missing dot (due to the malfunctioning nozzle) cannot be easily seen, and thus it is not necessary to compensate for the malfunctioning nozzle. However, when the photo paper, the coated paper, or the transparent film is used for printing, the malfunctioning nozzle may be compensated for.

When the malfunctioning nozzle is compensated for, the control unit 130 controls the printhead 111 to oscillate longitudinally with an oscillation amplitude of more than a single nozzle pitch according to the type of the print medium being used, and to eject ink when a normal nozzle (i.e., a functioning nozzle) is moved to a position where the malfunctioning nozzle is positioned for a previous ejection in operation S25. That is, the control unit 130 oscillates the printhead 111 in the second direction to compensate for the malfunctioning nozzle. The nozzle pitch indicates a distance between the adjacent nozzles.

The control unit 130 may control the printhead 111 to eject ink to compensate for the malfunctioning nozzle when the printhead 111 arrives at a position that corresponds to a maximum oscillation amplitude. This makes the movement of the printhead easier 11 to calculate and control, and does not require the carriage moving unit 161 (161′ ) to perform movements as precisely as if the oscillation amplitude is less than the single nozzle pitch. The printhead 111 is oscillated with the oscillation amplitude, which is an integer multiple of a single nozzle pitch, and ejects ink to compensate for the malfunctioning nozzle when a normal nozzle is moved to the position where the malfunctioning nozzle is positioned for the previous ejection. If ink is ejected while the normal nozzle is moving, it is difficult to accurately deposit the ink on a desired position that corresponds to the malfunctioning nozzle. Therefore, ink may be ejected when the printhead 111 arrives at the position that corresponds to the maximum oscillation amplitude because the printhead 111 is instantly stopped at this position.

The control unit 130 may control the printhead 111 to oscillate within five nozzle pitches with respect to an initial position of the printhead 111. In other words, the control unit 130 may control the printhead 111 to be moved five nozzle pitches in both directions with respect to the initial position of the printhead 111 (i.e., ten total nozzle pitches). The oscillation amplitude enables any malfunctioning nozzle in the printhead 111 to be compensated for even if one or both adjacent nozzles are also malfunctioning. As the oscillation amplitude of the printhead 111 oscillated is increased, it becomes more difficult for ink dots to be accurately deposited on the position that corresponds to the malfunctioning nozzle because of an influence of an acceleration of the printhead 111, a deceleration section, etc. That is, the control unit 130 may control the carriage moving unit 160 so as to oscillate the printhead 111 within five nozzle pitches with respect to the initial position of the printhead 111. It is possible that the control unit 130 may control the printhead 111 to be moved a distance with respect to a position of the malfunctioning nozzle according to the environment information including a state or position of the malfunctioning nozzle, a type of the printing medium, and a state of the carriage moving unit 161 (161′ ) such that one or more normal nozzles are disposed in the position of the malfunctioning nozzle.

FIGS. 13A through 13C illustrate printing patterns compensated for using the above described method of FIG. 12. Referring to FIG. 13A, if a single ink droplet is not deposited on the plain paper, a degradation due to the malfunctioning nozzle cannot be easily seen because of the feathering of adjacent ink dots. That is, when the ink droplets D1 are deposited on the plain paper, the ink is feathered along textures of cellulose in the plain paper to make the boundaries of the ink droplets D1 unclear. As a result the degradation due to the malfunctioning nozzle cannot be seen. However, ink droplets D2 and D3 deposited on the photo paper, the coated paper, or the transparent film have smaller sizes and clear boundaries, and thus a defect such as a white line due to the malfunctioning nozzle can be easily seen (see FIG. 11) when the malfunctioning nozzle is not compensated for.

Hereinafter, a high resolution printing method will be described in detail in conjunction with the operation of the control unit 130.

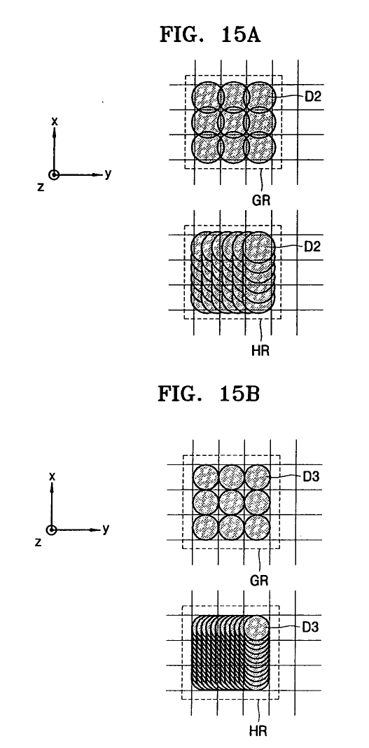

FIG. 14 is a flow chart of a high resolution printing method for an inkjet image forming apparatus according to an embodiment of the present general inventive concept. The method of FIG. 14 may be performed in the inkjet image forming apparatus 125. Accordingly, for illustration purposes, the method of FIG. 14 is described below with reference to FIGS. 3 to 9. FIG. 15A illustrates a printing pattern when printing with high resolution (i.e., the high resolution mode) on the photo paper or the coated paper. FIG. 15B illustrates a printing pattern when printing with high resolution on the transparent film.

Referring to FIGS. 8, 9 and 14, the image forming apparatus 125 receives the image data to be printed from the data input unit 135. The type of the print medium P is confirmed by the information input from the print medium confirming unit including the print medium detecting unit 122 and/or the user interface 240 in operation S50, and the information about the type of the print medium P is also transmitted to the control unit 130. The printing environment information such as the printing resolution is input from the user interface 240 in operation S55. For example, the user can select the print mode such as the draft mode, the normal mode, or the high resolution mode through the user interface 240.

The control unit 130 compares the printing resolution input from the data input device 135 and the actual resolution of the printhead 111, and a subsequent process is performed in operation S60. That is, the printing process can be changed (or adjusted) depending on whether the printing process is performed in the high resolution mode.

When the high resolution printing is not performed, the printing is performed in a mode set according to the existence (or absence) of a malfunctioning nozzle, as described in the method of FIG. 12, in operation S80.

The printing process is performed according to the type of the print medium P being used in the high resolution printing. That is, the transferring speed of the print medium P is determined according to the type of the print medium P in operation S65. The printhead 111 is oscillated according to the type of the print medium P being used, with the oscillation amplitude of more than a single nozzle pitch such that at least one ink dot is deposited on positions between ink dots previously ejected from the printhead 111 in operation S70.

Since it may be difficult to control the motion of the printhead 111 if the printhead 111 is oscillated with the oscillation amplitude of less than a single nozzle pitch, the printhead 111 may be oscillated with the oscillation amplitude of more than a single nozzle pitch. More specifically, the oscillation amplitude may be a multiple of the nozzle pitch.

The control unit 130 controls the printhead 111 to move in a stepwise manner in the longitudinal direction by a magnitude of D/N for “n” times printing with respect to an initial position of the printhead 111 and to eject at least one ink droplet onto each position of a D/N interval between two adjacent ink dots previously ejected at the initial position of the printhead 111. Here, “n” represents a natural number, “D” represents a distance between two adjacent nozzles (i.e., the nozzle pitch), and “N” represents a ratio of the desired printing resolution to the actual resolution of the printhead 111 as indicated by the nozzle pitch D. A number of ink dots deposited on positions between the two adjacent ink dots previously ejected at the initial position of the printhead 111 may be varied according to the type of the print medium P being used. That is, the number of ink dots ejected on the positions corresponding to the D/N interval(s) of space between the ink dots previously ejected from the nozzles at the initial position of the printhead 111 depends on the type of the print medium P being used. Thus, in the high resolution mode, “n” dots are printed between adjacent dots disposed at the nozzle pitch D. The “n” dots are ejected to one or more points located at the D/N intervals between the adjacent ink dots at the nozzle pitch D. For example, since sizes of the ink dots ejected on the transparent film are very small, ink may be ejected onto all positions corresponding to the D/N intervals of the space between the adjacent ink dots previously ejected from the nozzles at the initial position of the printhead 111 to enhance the printing resolution. Information about the number of ink dots ejected onto the space between the adjacent ink dots previously ejected when the printhead 111 is oscillated according to the type of the print medium P may be stored as table data in the printing environment information unit 136. Here, the number of ink dots ejected when the printhead 111 is oscillated may depend on the type of the print medium P being used and/or the printing environment, as described above. For example, when printing on the transparent film, ink dots may be ejected to each D/N interval according to a corresponding value of “n,” and when printing to the photo paper or the coated paper ink dots may be ejected to selected ones of the D/N intervals according to a corresponding value of “n.” Thus, values of “n” may be stored as the table data to correspond to the different types of print media R

In another embodiment of the present general inventive concept, the printhead 111 is oscillated in the longitudinal direction by a magnitude of (m/N)*D+(n*D) for N−1 printing times with respect to the initial position of the printhead 111 to eject at least one ink droplet onto each position of a D/N interval between two adjacent nozzles. Here, “n” represents an integral number, “D” represents the distance between two adjacent nozzles (i.e., the nozzle pitch) “N” represents a ratio of the desired printing resolution to the actual resolution of the printhead 111, and “m” represents a number which is sequentially changed from 1 up to N−1 whenever the printhead 111 is oscillated. Accordingly, the oscillation amplitude is changed whenever the printhead 111 is oscillated, and ink dots are deposited on positions between two adjacent ink dots previously ejected at the initial position of the printhead 111 such that the resolution along the second direction (i.e., the y direction) can be enhanced. Here, the ink may be ejected when the printhead 111 arrives at a position corresponding to the maximum oscillation amplitude. Accordingly, “m” tracks a number of oscillations while the maximum oscillation amplitude varies for each oscillation.

As described above, when printing with high resolution, the printhead 111 is moved in a stepwise manner along the longitudinal direction for “n” times or oscillated for N−1 times with various oscillation amplitudes to eject an ink droplet onto a position between two adjacent ink dots initially ejected, thereby enhancing the printing resolution. If the print medium P is transferred in the high resolution mode at the same transferring speed as in the normal mode, the resolution along the second direction (i.e., the y direction) which is the longitudinal direction of the printhead 111, can be enhanced, but the resolution in the first direction (i.e., the x direction) which is the transferring direction of the print medium P, is not enhanced. Accordingly, the control unit 130 controls the print medium transferring unit 500 to transfer the print medium P in the high resolution mode slower than in the normal mode.

The control unit 130 may control the print medium transferring unit 500 to transfer the print medium P at a 1/N speed with respect to the transferring speed in the normal mode. When the print medium P is transferred in the above described manner, the resolutions in the first and second directions each can be increased N times. Here, the control unit 130 may control the operation of the print medium transferring unit 500 to stop the transferring of the print medium P when ink is ejected. That is, in the present embodiment of, the print medium P is transferred at a 1/N speed and the printhead 111 is oscillated to print with high resolution when the transferring of the print medium P is stopped. After finishing one line of printing, the print medium P is subsequently transferred for printing to a next line. When printing with high resolution, the above described processes can be repeated such that all the image data is printed.

Alternatively, printing can be performed when the print medium P is continuously transferred. If the printhead 111 is oscillated “n” times, the transferring speed of the print medium P is reduced to a 1/n speed with respect to the transferring speed of the normal mode. If the printhead 111 is oscillated N−1 times while changing the oscillation amplitude, the transferring speed of the print medium P is reduced to a 1/n speed with respect to the transferring speed in the normal mode.

As illustrated in FIGS. 10 and 11, since the sizes of the ink dots vary with respect to the print medium P, the control unit 130 controls the oscillation amplitude, the stepwise moving distance of the printhead 111, and the transferring speed of the print medium P according to the type of the print medium P being used. Hereinafter, a high resolution printing method according to an embodiment of the present general inventive concept will be described. However, the present embodiment is not intended to limit the scope of the present general inventive concept.

When the plain paper is used, the resolution is not enhanced more than a certain resolution because the ejected ink feathers on the plain paper. Accordingly, the printhead 111 is not oscillated for printing on the plain paper. However, since the ink dots deposited on the photo paper, the coated paper, or the transparent film are smaller than ink dots deposited on the plain paper, the printhead 111 may be oscillated for printing on these print media P with high resolution. That is, when printing with high resolution, the printing is performed by changing the printing resolution according to the type of the print medium P. When printing with high resolution on the photo paper or the coated paper, the printing may be performed with a resolution twice the actual resolution of the printhead 111 as indicated by the nozzle pitch. When printing with high resolution on the transparent film, the printing may be performed with a resolution four times the actual resolution of the printhead 111.

Referring to FIG. 15A, when printing with high resolution on the photo paper or the coated paper, the print medium P may be transferred slower than in the normal mode. In the present embodiment, the print medium P is transferred at a half the transferring speed in the normal mode. Here, the reference character “GR” represents a printing pattern obtained in the normal mode and the reference character HR indicates a printing pattern obtained in the high resolution printing mode. The printing pattern HR has higher resolution than the printing pattern GR. That is, the resolutions in the first and second direction are doubled.

Referring to FIG. 15B, when printing with high resolution on the transparent film, the print medium P may be transferred slower than in the normal mode. In the present embodiment, the print medium P is transferred for printing at a quarter of the transferring speed in the normal mode. When the print medium P is the transparent film, the printhead 111 is oscillated to eject ink droplets at positions corresponding to ¼, ½, and ¾ of the distance between two adjacent ink dots previously ejected for printing. The printhead 111 may be moved in a stepwise manner to eject ink droplets, or may be oscillated for several times to eject an ink droplet(s) onto a desired position(s). Since the print medium P is transferred at a quarter of the transferring speed in the normal mode, the resolutions in the first and second direction are increased quadrupled. Although the embodiments of the present general inventive concept are described with reference to the plain paper, the photo paper, the coated paper, and the transparent film, it should be understood that other types of printing media may be used with these embodiments.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software. For example, the control unit 130 of the inkjet image forming apparatus 125 may be embodied in software, hardware, or a combination thereof.

As described above, unlike the conventional method, when a malfunctioning nozzle exists or when printing with high resolution, the embodiment of the present general inventive concept oscillates a carriage having a printhead with an oscillation amplitude within five nozzle pitches according to a type of print medium being used, thereby compensating for the malfunctioning nozzle and/or printing with high resolution.

As described above, an inkjet image forming apparatus and a printing method using the same according to the embodiments of the present general inventive concept perform a printing operation according to a type of print medium being used. When printing on plain paper, a printhead is not oscillated when a malfunctioning nozzle exists or when printing with high resolution. However, when printing on photo paper or a transparent film such as an OHP film, the printhead is oscillated to change positions where ink droplets are ejected from the same nozzle when a malfunctioning nozzle exists or when printing with high resolution. Thus, the printing is performed according to the type of the print medium being used, thereby increasing printing quality and printing speed.

When some nozzles in the printhead malfunction, the embodiments of the present general inventive concept oscillate a printhead in a longitudinal direction according to a type of the print medium being used and compensate for a malfunctioning nozzle using a normal nozzle, thereby reducing printing image degradation such as an appearance of white lines.

The embodiments of the present general inventive concept can realize high resolution printing by oscillating a printhead with various oscillation amplitudes according to a type of print medium being used, because an actual resolution of the printhead depends on a size of a nozzle pitch. For example, when photo paper or a transparent film are used, ink dots are deposited on positions between ink dots previously ejected on the print medium, thereby realizing higher resolution than the actual resolution of the printhead.

When compensating for a malfunctioning nozzle or printing with high resolution, the embodiments of the present general inventive concept can minimize a registration error due to acceleration or deceleration of a printhead by ejecting ink when the printhead is moved with a uniform speed or when the printhead ejects ink in a stopped position.

The embodiments of the present general inventive concept detect a type of print medium using a print medium detecting unit installed in an image forming apparatus so that the print medium can be printed fast, and confirms the type of the print medium using a print medium confirming unit according to each printing environment so that high printing quality can be achieved for various printing environments and/or print medium types.

As described above, the embodiments of the present general inventive concept can realize proper printing quality by adjusting an oscillation amplitude and a number of oscillations of the printhead according to a print medium being used.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
a print medium detecting unit to detect a type of a print medium being used;
a print medium transferring unit to transfer the print medium in a first direction;
a printhead having a nozzle unit with a length that corresponds to a width of the print medium and being installed along a second direction to eject ink onto the print medium to form an image;
a carriage movably installed along the second direction and in which the printhead is mounted;
a carriage moving unit to oscillate the carriage in the second direction;
a malfunctioning nozzle detecting unit to detect whether a malfunctioning nozzle exists in the nozzle unit; and
a control unit to generate control signals, when the malfunctioning nozzle is detected to exist, to oscillate the carriage with an oscillation amplitude of more than a single nozzle pitch according to the detected type of the print medium, and to synchronously control the transferring operation of the print medium transferring unit, the ejecting operation of the printhead, and the oscillation operation of the carriage moving unit to compensate for the malfunctioning nozzle by ejecting ink when a normal nozzle is moved to a position where the malfunctioning nozzle is positioned for a previous ejection operation.

2. The apparatus of claim 1, wherein the control unit generates a control signal to eject ink in order to compensate for the malfunctioning nozzle when the carriage arrives at a position that corresponds to a maximum oscillation amplitude.

3. The apparatus of claim 1, wherein the control unit generates a control signal to control motion of the carriage moving unit such that the oscillation amplitude of the carriage is within five nozzle pitches.

4. The apparatus of claim 1, wherein the printhead comprises a plurality of head chips that have a plurality of nozzle arrays and are arranged in the second direction.

5. The apparatus of claim 4, wherein the plurality of head chips are arranged in the printhead in zigzag formation.

6. The apparatus of claim 1, wherein the printhead comprises nozzle arrays that have lengths that correspond to the width of the print medium and are arranged along the second direction.

7. An inkjet image forming apparatus comprising:
a print medium confirming unit to confirm a type of a print medium to be used;
a print medium transferring unit to transfer the print medium in a first direction;
a printhead which has a nozzle unit with a length that corresponds to a width of the print medium and being installed along a second direction to eject ink onto the print medium to form an image;
a carriage movably installed along the second direction and in which the printhead is mounted;
a carriage moving unit to oscillate the carriage in the second direction;
a malfunctioning nozzle detecting unit to detect whether a malfunctioning nozzle exists in the nozzle unit; and
a control unit to generate control signals, when the malfunctioning nozzle is detected, to oscillate the carriage with an oscillation amplitude of more than a single nozzle pitch according to the confirmed type of the print medium, and to synchronously control the transferring operation of the print medium transferring unit, the ejecting operation of the printhead, and the operation of the carriage moving unit to compensate for the malfunctioning nozzle by ejecting ink when a normal nozzle is moved to a position where the malfunctioning nozzle is positioned for a previous ejection operation.

8. The apparatus of claim 7, wherein the control unit generates a control signal to eject ink in order to compensate for the malfunctioning nozzle when the carriage arrives at a position that corresponds to a maximum oscillation amplitude.

9. The apparatus of claim 7, wherein the control unit generates a control signal to control motion of the carriage moving unit such that the oscillation amplitude of the carriage is within five nozzle pitches.

10. An image forming apparatus, comprising:
a printhead having a plurality of nozzles and a length that corresponds to a width of a print medium; and
a control unit to control movement and operation of the printhead to print in a first resolution mode when a first type of print medium is printed and to print in a second resolution mode when a second type of print medium is printed.

11. The apparatus of claim 10, wherein the first and second resolution modes comprise first and second high resolution modes, respectively.

12. The apparatus of claim 10, wherein the printhead has a corresponding actual resolution defined by a nozzle pitch thereof, the first resolution mode has a first resolution that is a multiple of the actual resolution, and the second resolution mode has a second resolution that is another multiple of the actual resolution.

13. The apparatus of claim 10, wherein the first and second types of print media including at least two of a plain paper, a photo paper, a coated paper, and a transparent film.

14. The apparatus of claim 10, further comprising one or more of:
a print medium type detecting unit to detect a type of the print medium to be printed and to provide information about the detected type of print medium to the control unit; and
an interface to receive a user command to indicate the type of print medium to be printed and to provide the indicated type of the printed medium to the control unit.

15. The apparatus of claim 10, wherein the control unit determines a type of print medium, selects a normal resolution mode when the determined printed medium is normal paper, selects from a plurality of high resolution modes based on an ink spreading characteristic of the determined print medium when the determined print medium is not the normal paper, and controls the printhead accordingly.

16. The apparatus of claim 10, further comprising:
a print medium transferring unit to transfer the print medium at one of a plurality of different speeds,
wherein the control unit controls the print medium transferring unit to transfer the print medium at a first speed when controlling the printhead to print in the first resolution mode and a second speed when controlling the printhead to print in the second resolution mode.

17. The apparatus of claim 10, further comprising:
a malfunctioning nozzle detection unit to detect whether a malfunctioning nozzle exists in the printhead and to provide information about whether the malfunctioning nozzle exists to the control unit,
wherein the control unit controls the printhead to perform an initial ink ejection at an initial position and then moves the printhead back and forth in a widthwise direction of the print medium with respect to the initial position by a multiple of a single nozzle pitch such that a functioning nozzle that is the multiple of the single nozzle pitch away from the malfunctioning nozzle ejects ink to an area on the print medium that corresponds to the malfunctioning nozzle.

18. The apparatus of claim 10, wherein the control unit controls the printhead to perform an initial ink ejection to eject at least two adjacent ink dots to the print medium, controls the printhead to eject a first number of additional ink dots in-between the at least two adjacent ink dots when the print medium is the first type of print medium, controls the printhead to eject a second number of additional ink dots in-between the at least two adjacent ink dots when the print medium is the second type of print medium, and controls the printhead to eject zero additional ink dots in-between the at least two adjacent ink dots when the print medium is a third type of print medium.

19. The apparatus of claim 10, wherein the control unit controls the printhead to move in a stepwise manner in a longitudinal direction of the printhead in increments that are less than a nozzle pitch to print to the print medium when printing in a high resolution mode.

20. An image forming apparatus, comprising:
a printhead having a plurality of nozzles and a length that corresponds to a width of a print medium; and
a control unit to determine whether a malfunctioning nozzle exists in the printhead, to control the printhead to perform an initial ink ejection at an initial position, to control the printhead to move back and forth by a multiple of a single nozzle pitch such that a functioning nozzle that is the multiple of the single nozzle pitch away from the malfunctioning nozzle ejects ink to an area on the print medium that corresponds to the malfunctioning nozzle.

21. The apparatus of claim 20, wherein the control unit moves the printhead back and forth by a magnitude of (m/N)*D+(n*D) for N−1 printing times with respect to the initial position of the printhead to eject at least one ink droplet onto each position of a D/N interval between two adjacent nozzles, where “n” represents an integer, “D” represents the nozzle pitch, “N” represents a ratio of a desired printing resolution to an actual resolution of the printhead as defined by the nozzle pitch D, and “m” represents a number which is sequentially changed from 1 up to N−1 whenever the printhead is oscillated.

22. The apparatus of claim 20, further comprising:
a printing environment information unit to receive a desired resolution to print,
wherein the control unit controls the printhead to move back and forth a number of times with a decreasing distance with respect to the initial position based on the desired resolution and an actual resolution of the printhead.

23. An image forming apparatus, comprising:
a printhead having a plurality of nozzles spaced apart by a nozzle pitch and a length that corresponds to a width of a print medium;
a malfunctioning nozzle detection unit to detect whether a malfunctioning nozzle exists in the printhead; and
a control unit to control the printhead to oscillate with an amplitude of more than one nozzle pitch such that a functioning nozzle ejects ink to an area of the print medium having a missing dot from the malfunctioning nozzle.

24. The apparatus of claim 23, wherein the control unit determines a type of the printing medium to be printed and selects the oscillation amplitude from among a plurality of amplitudes that correspond to different types of print media.

25. An image forming apparatus, comprising:
a printhead having a plurality of nozzles and a length that corresponds to a width of a print medium;
a print medium determining unit to determine a type of the print medium to be printed;
a malfunctioning nozzle detection unit to detect whether a malfunctioning nozzle exists in the printhead; and
a control unit to receive information about the determined type of print medium and whether the malfunctioning nozzle exists and to control longitudinal movement and operation of the printhead based on the information received from the print medium determining unit and the malfunctioning nozzle detection unit.

26. An image forming apparatus comprising:
a printhead having a plurality of nozzles to form an image on a printing medium; and
a control unit to detect at least one of the plurality nozzles as a malfunctioning nozzle, and to control the printhead to move a distance with respect to a position of the malfunctioning nozzle according to information on a state of the malfunctioning nozzle, a type of the printing medium, and a state of the printhead.

27. A method of compensating for a malfunctioning nozzle in an inkjet image forming apparatus having a printhead including a nozzle unit with a length corresponding to a width of a print medium, the method comprising:
confirming a type of the print medium to be printed;
detecting whether a malfunctioning nozzle exists in the nozzle unit;
determining to compensate for the malfunctioning nozzle according to the type of the print medium when the malfunctioning nozzle exists; and
compensating for the malfunctioning nozzle by longitudinally oscillating the printhead with an oscillation amplitude of more than a single nozzle pitch according to the confirmed type of the print medium and ejecting ink when a normal nozzle is moved to a position where the malfunctioning nozzle is positioned for a previous ejection operation.

28. The method of claim 27, wherein the confirming of the type of print medium comprises detecting the type of the print medium using a light-emitting sensor and a light-receiving sensor.

29. The method of claim 27, wherein the confirming of the type of print medium comprises enabling confirmation of the type of the print medium for printing via a user interface.

30. The method of claim 27, wherein the compensating for the malfunctioning nozzle comprises ejecting ink to compensate for the malfunctioning nozzle when the printhead arrives at a position that corresponds to a maximum oscillation amplitude.

31. The method of claim 27, wherein the compensating for the malfunctioning nozzle comprises controlling the printhead to oscillate within five nozzle pitches.

32. A high resolution printing method for an inkjet image forming apparatus having a printhead including a nozzle unit with a length corresponding to a width of a print medium, the method comprising:
confirming a type of the print medium to be printed;
receiving a desired resolution for printing from a host;
comparing the desired resolution and an actual resolution of the printhead;
determining whether to oscillate the printhead according to the confirmed type of the print medium, when the desired resolution is greater than the actual resolution of the printhead; and
printing with high resolution by longitudinally oscillating the printhead with an oscillation amplitude of more than a single nozzle pitch according to the confirmed type of the print medium such that at least one ink dot is deposited on a position between two adjacent ink dots that are previously ejected.

33. The method of claim 32, wherein the confirming of the type of print medium to be printed comprises detecting the type of the print medium using a light-emitting sensor and a light-receiving sensor.

34. The method of claim 32, wherein the confirming of the type of print medium to be printed comprises enabling confirmation of the type of the print medium to be printed via a user interface.

35. The method of claim 32, wherein the printing comprises:
moving the printhead in a stepwise manner in the longitudinal direction by a magnitude of D/N for “n” print times with respect to an initial position of the printhead such that at least one ink dot is ejected onto each position of a D/N interval between two adjacent ink dots previously ejected,
where “n” represents a natural number, “D” represents a distance between two adjacent nozzles and a nozzle pitch, and “N” represents a ratio of the desired resolution to the actual resolution of the printhead.

36. The method of claim 35, wherein the print medium is transferred at 1/N of a print medium transferring speed in a normal printing mode in which the image forming apparatus does not print with the high resolution.

37. The method of claim 32, wherein the printing comprises:
oscillating the printhead in the longitudinal direction by a magnitude of (m/N) * D +(n * D) for N−1 printing times with respect to an initial position of the printhead to eject at least one ink droplet onto each position of a D/N interval between two adjacent nozzles, where “n” represents an integral number, “D” represents a distance between two adjacent nozzles and a nozzle pitch, “N” represents a ratio of the desired resolution to the actual resolution of the printhead, and “m” represents a number which is sequentially changed from 1 up to N−1 whenever the printhead is oscillated.

38. The method of claim 37, wherein the printhead ejects ink when the printhead arrives at a position that corresponds to a maximum oscillation amplitude.

39. The method of claim 37, wherein the print medium is transferred at 1/N of a print medium transferring speed in a normal printing mode in which the image forming apparatus does not print with the high resolution.

40. The method of claim 32, wherein the print medium is transferred for printing slower than in a normal printing mode in which the image forming apparatus does not print with the high resolution.

41. A method of controlling an image forming apparatus including a printhead having a plurality of nozzles and a length that corresponds to a width of a print medium, the method comprising:
controlling movement and operation of the printhead to print in a first resolution mode when a first type of print medium is printed; and
controlling movement and operation of the printhead to print in a second resolution mode when a second type of print medium is printed.

42. A method of controlling an image forming apparatus including a printhead having a plurality of nozzles and a length that corresponds to a width of a print medium, the method comprising:
determining whether a malfunctioning nozzle exists in the printhead;
controlling the printhead to perform an initial ink ejection at an initial position thereof; and
controlling the printhead to move back and forth by a multiple of a single nozzle pitch such that a functioning nozzle that is the multiple of the single nozzle pitch away from the malfunctioning nozzle ejects ink to an area on the print medium that corresponds to the malfunctioning nozzle.

43. A method of controlling an image forming apparatus including a printhead having a plurality of nozzles spaced apart by a nozzle pitch and a length that corresponds to a width of a print medium, the method comprising:
detecting whether a malfunctioning nozzle exists in the printhead; and
controlling the printhead to oscillate with an amplitude of more than one nozzle pitch such that a functioning nozzle ejects ink to an area of the print medium having a missing dot from the malfunctioning nozzle.

44. A method of controlling an image forming apparatus including a printhead having a plurality of nozzles and a length that corresponds to a width of a print medium, the method comprising:
determining a type of the print medium to be printed;
detecting whether a malfunctioning nozzle exists in the printhead; and
controlling longitudinal movement and operation of the printhead based on an indication of whether the malfunctioning nozzle exists and information about the determined type of print medium.
